(19) United States
(12) Patent Application Publication
(10) Pub. No.: US 2012/0075233 A1
(43) Pub. Date: Mar. 29, 2012

(54) DEVICE DISPLAY WITH A TOUCH SENSOR

(75) Inventors: Karthik Lakshminarayanan, Ronkonkoma, NY (US); Travis G. Baldwin, Dix Hills, NY (US); Eric M. Johnson, Leiden (NL); Brian C. McHale, Massapequa, NY (US)

(73) Assignee: SYMBOL TECHNOLOGIES, INC., SCHAUMBURG, IL (US)

(21) Appl. No.: 12/892,864

(22) Filed: Sep. 28, 2010

(51) Int. Cl. G06F 3/045

(52) U.S. Cl. 345/174

(57) ABSTRACT

A device display with a touch sensor includes a housing bezel, a plain clear substrate, and a display panel. The display includes a circuit board having a display aperture, the circuit board disposed between the clear substrate and display panel, and assembled with the housing bezel such that a portion of the display can be viewed through a bezel aperture. Sensor electrodes are disposed around the display aperture of the circuit board. A capacitive touch controller generates an electric field between sensor electrodes such that the electric field extends through and above the clear substrate. The controller can then detect a disturbance in the electric field above the clear substrate within and along a periphery of the bezel aperture.

### FIELD OF THE DISCLOSURE

The present invention relates generally to displays for an electronic device and more particularly to a device display with a touch sensor.

### BACKGROUND

Electronic devices are increasingly using more sophisticated display technologies, including liquid crystal displays, electroluminescent diode displays, organic light emitting diode displays, bistable displays, etc. Some of these devices have displays adapted to be touch-sensitive in order to eliminate the need for many control buttons on the face of the device, and thereby allowing the use of a bigger display which is a desirable feature for users of the device.

For example, hand-held electronic devices can have display screens that incorporate touch-sensitive layers. Typically, such layers consist of electrically-conductive indium tin oxide that is deposited on a clear substrate and that is patterned to provide the touch-sensitive function. These patterned indium tin oxide layers can detect the proximity of a user's finger through resistive or capacitive changes. The advantage of such indium tin oxide touch screens is that they are optically transparent, and therefore can be utilized to detect a user's finger anywhere across the surface of a display screen. The disadvantage of such touch screens is that they are quite expensive at this time, and therefore are not cost effective for electronic devices that do not have a need for extensive touch-sensitivity functionality or that have a relatively low overall cost requirement.

Accordingly, there is a need for a device display with a touch sensor that is simpler and lower cost than an indium tin oxide touch screen, while still approximating its function.

### BRIEF DESCRIPTION OF THE FIGURES

The accompanying figures, where like reference numerals refer to identical or functionally similar elements throughout the separate views, together with the detailed description below, are incorporated in and form part of the specification, and serve to further illustrate embodiments of concepts that include the claimed invention, and explain various principles and advantages of those embodiments.

FIG. 1 is a top view of a device display, in accordance with one embodiment of the present invention.

FIG. 2 is a side, cross-sectional view of the sensor of the device display of FIG. 1.

FIG. 3 is a side, cross-sectional of an alternate sensor configuration for the device display, in accordance with some embodiments of the present invention.

FIG. 4 is a first side, cross-sectional view of the device display of FIG. 1.

FIG. 5 is a second side, cross-sectional view of the device display, in accordance with some embodiments of the present invention.

FIG. 6 is a third side, cross-sectional view of the device display, in accordance with other embodiments of the present invention.

FIG. 7 is a fourth side, cross-sectional view of the device display, in accordance with other embodiments of the present invention.

FIG. 8 is a top view of a first circuit board with sensors, in accordance with one embodiment of the present invention.

FIG. 9 is a top view of a second circuit board with sensors, in accordance with another embodiment of the present invention.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

The apparatus and method components have been represented where appropriate by conventional symbols in the drawings, showing only those specific details that are pertinent to understanding the embodiments of the present invention so as not to obscure the disclosure with details that will be readily apparent to those of ordinary skill in the art having the benefit of the description herein.

### DETAILED DESCRIPTION

An apparatus is described that provides a device display with a touch sensor that is simpler and lower cost than an indium tin oxide touch screen, while still approximating its function. In particular, the present invention deploys custom capacitive sensors around the periphery of a display screen. The touch sensors are easily provided on a circuit board using low-cost techniques. Although, the touch sensitivity of the sensors does not extend through the entire display area of the device, they are much lower cost than an indium tin oxide touch screen. In addition, different embodiments are presented that partially extend the touch sensors of the present invention into the display area.

Devices that use touch sensitive displays are known to refer to a wide variety of consumer electronic platforms such as cellular radiotelephones, user equipment, subscriber stations, access terminals, remote terminals, terminal equipment, cordless handsets, gaming devices, personal computers, and personal digital assistants, and the like, all referred to herein as devices. Each device comprises a processor that can be further coupled to a keypad, a speaker, a microphone, a display, and other features, as are known in the art and therefore not shown. The device can also include a capacitive touch controller to operate the custom touch sensors, in accordance with the present invention. It should be recognized that the controller can be a stand-alone module or can be incorporated into the processor.

The figures show various assemblies adapted to support the inventive concepts of the embodiments of the present invention. Those skilled in the art will recognize that these figures do not depict all of the equipment necessary for the device and display to operate but only those components particularly relevant to the description of embodiments herein. For example, the device can include separate processors, controllers, communication interfaces, transceivers, memories, etc. In general, components such as processors, controllers, memories, and interfaces are well-known. For example, processing and controlling units are known to comprise basic components such as, but not limited to, microprocessors, microcontrollers, memory cache, application-specific integrated circuits (ASICs), and/or logic circuitry.

Those skilled in the art are aware of the many design and development techniques available to configure a processor and a controller that implement the touch-sensitive control of a display. Therefore, the entities shown represent a known system that has been adapted, in accordance with the description herein, to implement various embodiments of the present invention. Furthermore, those skilled in the art will recognize that aspects of the present invention may be implemented in and across various physical components and none are necessarily limited to single platform implementations. It is within the contemplation of the invention that the operating requirements of the present invention can be implemented in software, firmware or hardware, with the function being implemented in a software processor (or a digital signal processor) being merely an option.

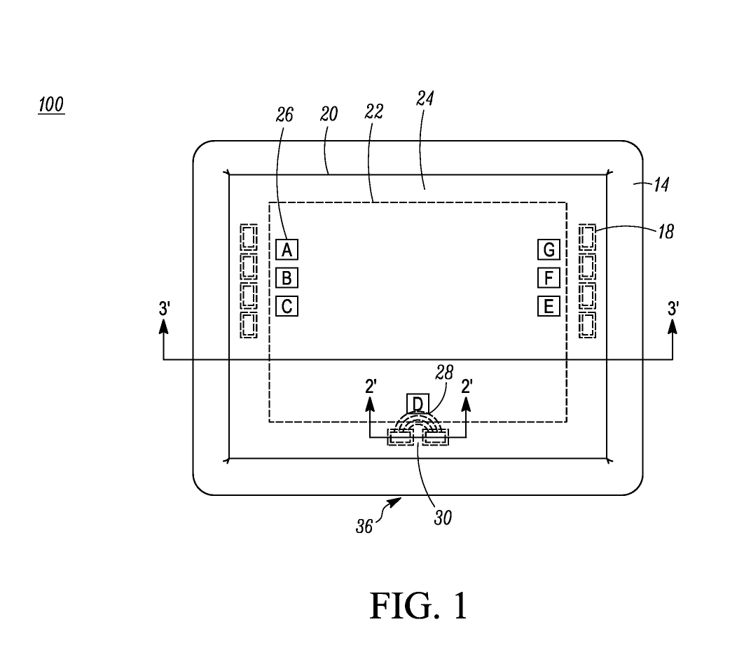

Referring to FIG. 1, a device display 100 is shown with custom touch sensors, in accordance with the present invention. The display 100 includes a housing bezel 14, a plain clear substrate 10, a circuit board 16, and a display panel 12. The housing bezel 14 can be of any material. However, a plastic bezel will be less likely to interfere with the electric field 28 generated by each sensor 36, as will be detailed below. The clear substrate 10 can be of clear shot plastic or glass. The clear substrate is “plain” inasmuch as it is not processed with any patterned conductive layers as is done in the prior art. The display panel 12 can be a liquid crystal display, electroluminescent diode display, organic light emitting diode display, bistable display, and the like, which can be controlled by a processor as are all known in the art. The bezel housing 14 has a bezel aperture 20 that borders the display 100. The bezel aperture defines a maximum possible viewing area of the display 100. The circuit board 16 has a display aperture 22 that defines a minimum possible viewing area of the display 100. As assembled, the circuit board 16 abuts the clear substrate 10 and the display panel 12 abuts the circuit board 16, wherein the clear substrate 10, circuit board 16, and display panel 12 are assembled with the housing bezel 14 such that a portion of the display can be viewed through the bezel aperture 20, through the clear substrate 10, and through the display aperture 22.

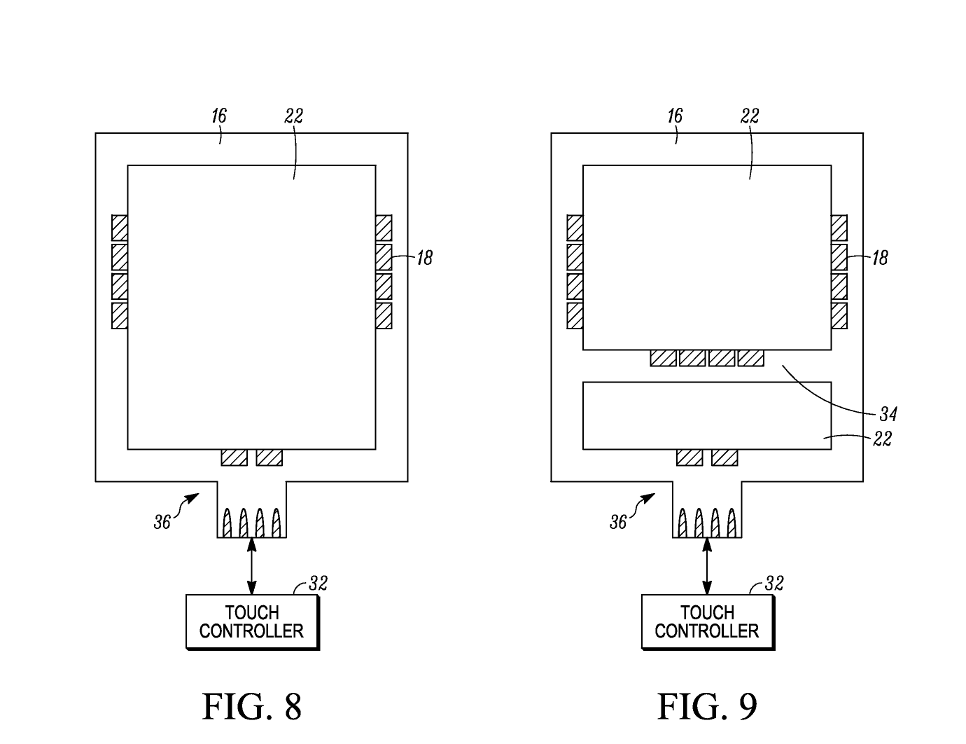

The circuit board 16 can be a standard printed circuit board, made of a known epoxy or FR4 composite for example, or a flexible circuit, made of known Kapton® tape material for example. The circuit board 16 includes a plurality of conductive (e.g. metal) sensor electrodes 18, which are configured with the circuit board 16 to provide strategically-placed custom sensors 36, to touch-sensitize peripheral regions of the display 100 in accordance with the present invention. In particular, the electrodes are disposed around the display aperture of the circuit board. In practice, the present invention also includes a capacitive touch controller (see 32 in FIG. 8) for controlling each sensor 36.

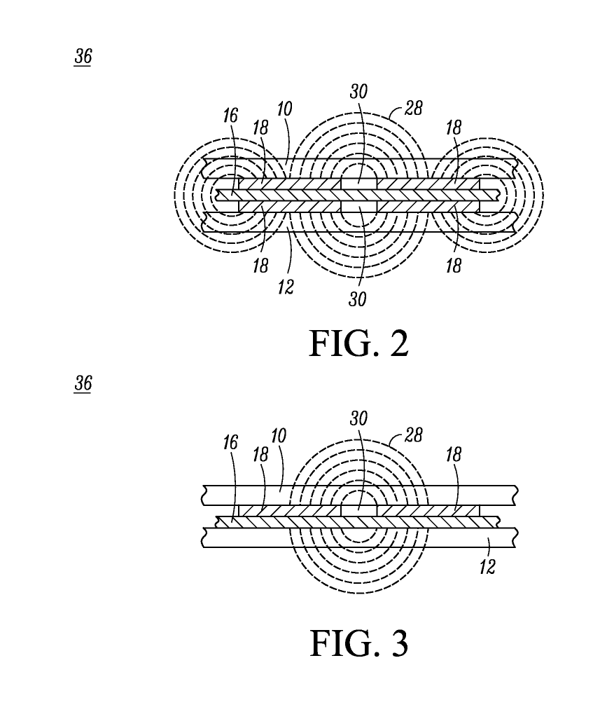

Referring to FIGS. 1 and 2, a capacitive sensor 36 in accordance with the present invention includes two pairs of parallel electrodes 18 separated by a gap 30. An electric field 28 generated between the pairs provide mutual capacitance. The field is generated between electrode pairs by a touch controller that charges and discharges the pairs in frequency bursts. The resultant electric field is of sufficient strength to extend through and above the clear substrate 10, which has an appropriate permittivity to accomplish this. In particular, a permittivity could be chosen to enhance the penetration of the electric field through and above the clear substrate. The electric field can extend substantially spherically with field components both perpendicular above the electrode pairs (as shown in FIG. 2) and also in parallel around the electrode pairs (as shown in FIG. 1). A user's finger placed above the clear substrate in proximity to the sensor will change the mutual capacitance between the electrode pairs and across the gap resulting in a disturbance to the electric field that is of a sufficient magnitude to be detected by the touch controller. There should be very little to no airgap between the top electrode and the clear substrate in order to maximize the electric field above the clear substrate.

FIG. 3 shows an alternate capacitive sensor 36 in accordance with the present invention which includes two coplanar electrodes 18 separated by a gap 30. As above an electric field 28 is generated across this gap 30 by a touch controller. The electric field is of sufficient strength to extend through and above the clear substrate 10. Again, the electric field can extend substantially spherically with field components both perpendicular above the electrodes (as shown in FIG. 3) and also in parallel around from the electrodes (as shown in FIG. 1). A user's finger placed above the clear substrate in proximity to the sensor will change the self capacitance across the gap resulting in a disturbance to the electric field that is of a sufficient magnitude to be detected by the touch controller. There should be very little to no airgap between the electrodes and the clear substrate in order to maximize the electric field above the clear substrate.

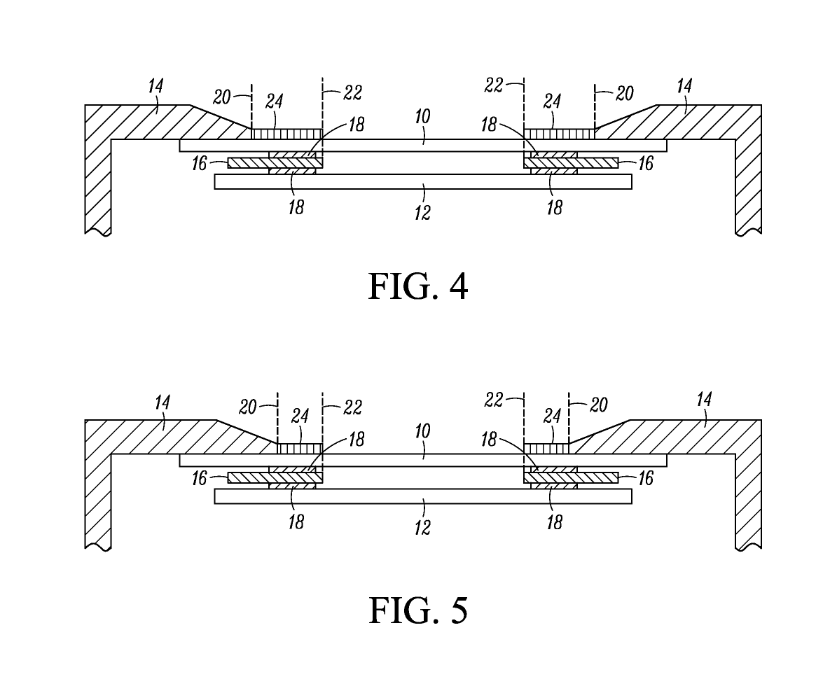

Referring to FIGS. 1 and 4, in this embodiment the sensor electrodes 18 on the circuit board 16 are wholly disposed within the bezel aperture 20 (as viewed from above through the bezel aperture). In effect, the display aperture 22 is smaller than the bezel aperture 20. Therefore, the location of the electrodes is between the peripheries of the display aperture 22 and bezel aperture 20. In this configuration, the electrodes 18 would be visible through the clear substrate 10. Therefore, for aesthetic reasons, an opaque coating 24 or paint is disposed on the glass substrate 10 between the display aperture 22 and bezel aperture 20 in order to conceal the electrodes 18 from view (as viewed from above through the bezel aperture). This coating 24 should have a permittivity allowing the electric field 28 to penetrate the coating 24 above the glass substrate 10. Preferably, the permittivity should have a similar permittivity as the glass substrate 10.

Referring to FIG. 5, in this embodiment the sensor electrodes 18 on the circuit board 16 are at least partially disposed under the bezel 14 (as viewed from above through the bezel aperture). Again, the display aperture 22 is smaller than the bezel aperture 20. The location of the electrodes is beyond the periphery of the display aperture 22 and skirts the bezel aperture 20. In this configuration, the electrodes 18 would still be visible through the clear substrate 10. Therefore, for aesthetic reasons, an opaque coating 24 would still be used, as above. This configuration results in a larger available viewing area from the display panel 12, but requires that the sensor electric field strength is still sufficient to extend above the glass substrate 10 within the bezel aperture 20 to be disturbed by a user.

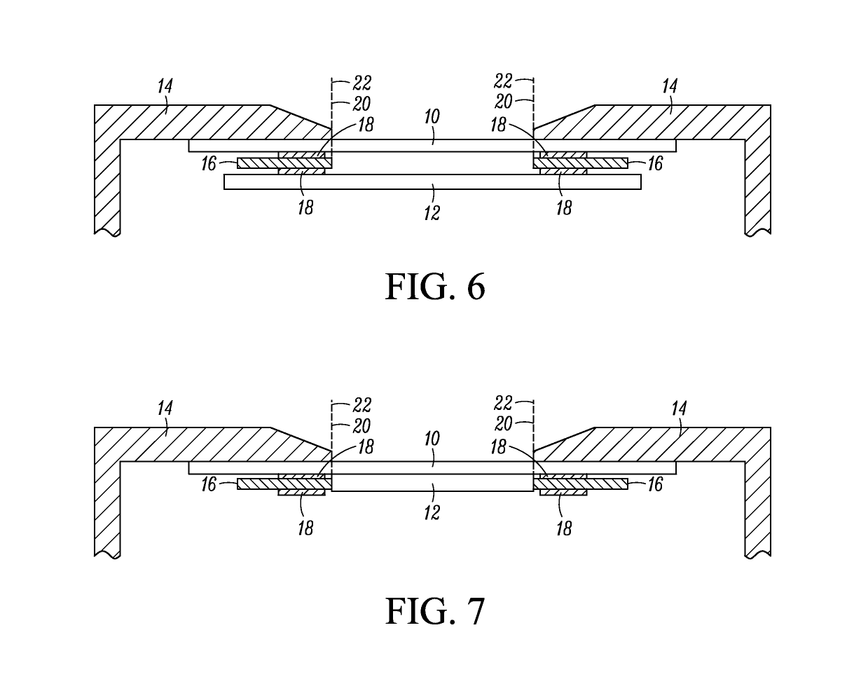

Referring to FIG. 6, in this embodiment the sensor electrodes 18 on the circuit board 16 are wholly disposed under the bezel 14 (as viewed from above through the bezel aperture). The display aperture 22 is no longer smaller than the bezel aperture 20, and preferably is the same size. The location of the electrodes is beyond the periphery of both the display aperture 22 and the bezel aperture 20. In this configuration, the electrodes 18 would no longer be visible through the clear substrate 10. Therefore, an opaque coating 24 is no longer needed. This configuration results in a maximum available viewing area from the display panel 12, but requires that the sensor electric field strength is still sufficient to extend above the glass substrate 10 within the bezel aperture 20 to be disturbed by a user.

Referring to FIG. 7, in this embodiment the display panel 12 is located (coplanar) within the circuit board display aperture 22. In this case, the display panel abuts both the circuit board 16 and the clear substrate 10. It should be recognized that this embodiment could be incorporated into any of the embodiments of FIGS. 4-6. This configuration results in a minimum thickness of the device display.

Referring back to FIG. 1, the display panel is configured to display at least one icon 26 (i.e. A through G) in proximity to an electric field of sensor electrodes near a periphery of the display aperture. In effect, the device display is tailored such that the icons are placed around the periphery of the display. For example, icon D is shown located next to a gap 30 of a sensor, where an electric field 28 is present. A user placing a finger over icon D will disturb the electric field 28, thereby activating that sensor 36. The icon is configured in the display panel 12 to represent a function (i.e. function “D”). A disturbance of the electric field 28 in proximity to the icon 26 will cause the touch controller to initiate the execution of that function. The presentation and control of icons is known in the art and can be accomplished by a separate processor or even the touch controller 32 itself. If a separate processor is used, the location of icons and sensors can be correlated with the touch controller. The touch controller will send a signal to the processor indicating that the sensor next to icon D has been activated, and the processor can then take the action dictated for that function. This operation is much simplified, if the touch controller controls both the sensors and the icon.

FIG. 8 represents a circuit board configuration that can be used in any embodiment of the present invention. As shown and as described previously, sensors 36 are disposed around a display aperture 22. Upon assembly into the device display, activation of these sensors can only occur around a periphery of the display, wherein the center of the display will have no touch-sensitivity. If more sensors are desired, such as in the case where the number or arrangement of icons/sensors becomes too crowded on the display, the present invention envisions that the circuit board can include a bridge 34 disposed across the display aperture, wherein further sensor electrodes are disposed on the bridge 34, as shown in FIG. 9. Although this configuration will permanently block a portion of the display panel nearer the center of the display, an increase in the number of available icon functions can be provided as needed.

Advantageously, the present invention provides a touch sensor for a device display that is simpler and lower cost than an indium tin oxide touch screen, while still approximating its function. In particular, the present invention deploys custom capacitive sensors around the periphery of a display screen. The touch sensors are easily provided on a circuit board using low-cost techniques. These touch sensors can be partially extend into the display area.

In the foregoing specification, specific embodiments have been described. However, one of ordinary skill in the art appreciates that various modifications and changes can be made without departing from the scope of the invention as set forth in the claims below. Accordingly, the specification and figures are to be regarded in an illustrative rather than a restrictive sense, and all such modifications are intended to be included within the scope of present teachings.

The benefits, advantages, solutions to problems, and any element(s) that may cause any benefit, advantage, or solution to occur or become more pronounced are not to be construed as a critical, required, or essential features or elements of any or all the claims. The invention is defined solely by the appended claims including any amendments made during the pendency of this application and all equivalents of those claims as issued.

Moreover in this document, relational terms such as first and second, top and bottom, and the like may be used solely to distinguish one entity or action from another entity or action without necessarily requiring or implying any actual such relationship or order between such entities or actions. The terms “comprises,” “comprising,” “has”, “having,” “includes”, “including,” “contains”, “containing” or any other variation thereof, are intended to cover a non-exclusive inclusion, such that a process, method, article, or apparatus that comprises, has, includes, contains a list of elements does not include only those elements but may include other elements not expressly listed or inherent to such process, method, article, or apparatus. An element proceeded by “comprises . . . a”, “has . . . a”, “includes . . . a”, “contains . . . a” does not, without more constraints, preclude the existence of additional identical elements in the process, method, article, or apparatus that comprises, has, includes, contains the element. The terms “a” and “an” are defined as one or more unless explicitly stated otherwise herein. The terms “substantially”, “essentially”, “approximately”, “about” or any other version thereof, are defined as being close to as understood by one of ordinary skill in the art, and in one non-limiting embodiment the term is defined to be within 10%, in another embodiment within 5%, in another embodiment within 1% and in another embodiment within 0.5%. The term “coupled” as used herein is defined as connected, although not necessarily directly and not necessarily mechanically. A device or structure that is “configured” in a certain way is configured in at least that way, but may also be configured in ways that are not listed.

It will be appreciated that some embodiments may be comprised of one or more generic or specialized controllers of processors such as microprocessors, digital signal processors, customized processors and field programmable gate arrays (FPGAs) and unique stored program instructions (including both software and firmware) that control the one or more processors to implement, in conjunction with certain non-processor circuits, some, most, or all of the functions of the method and/or apparatus described herein. Alternatively, some or all functions could be implemented by a state machine that has no stored program instructions, or in one or more application specific integrated circuits (ASICs), in which each function or some combinations of certain of the functions are implemented as custom logic. Of course, a combination of the two approaches could be used.

Moreover, an embodiment can be implemented as a computer-readable storage medium having computer readable code stored thereon for programming a computer (e.g., comprising a processor) to perform a method as described and claimed herein. Examples of such computer-readable storage mediums include, but are not limited to, a hard disk, a CD-ROM, an optical storage device, a magnetic storage device, a ROM (Read Only Memory), a PROM (Programmable Read Only Memory), an EPROM (Erasable Programmable Read Only Memory), an EEPROM (Electrically Erasable Programmable Read Only Memory) and a Flash memory. Further, it is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation.

The Abstract of the Disclosure is provided to allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in various embodiments for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separately claimed subject matter.

What is claimed is:

1. A device display with touch sensor, the display comprising:
a housing bezel with a bezel aperture;
a clear substrate;
a display panel;
a circuit board having a display aperture, the circuit board abutting the clear substrate and the display panel abutting the circuit board, wherein the clear substrate, circuit board, and display panel are assembled with the housing bezel such that a portion of the display can be viewed through the bezel aperture, through the clear substrate, and through the display aperture; and
a plurality of sensor electrodes disposed around the display aperture of the circuit board.

2. The display of claim 1, wherein the sensor electrodes are wholly disposed within the bezel aperture, as viewed through the bezel aperture.

3. The display of claim 1, wherein the sensor electrodes are at least partially disposed under the housing bezel, as viewed through the bezel aperture.

4. The display of claim 3, wherein the display aperture is smaller than the bezel aperture.

5. The display of claim 3, wherein the clear substrate includes an opaque coating covering the sensor electrodes as viewed through the bezel aperture.

6. The display of claim 5, wherein the opaque coating has a similar permittivity as the clear substrate.

7. The display of claim 1, wherein the display aperture is not smaller than the bezel aperture, and wherein the sensor electrodes are wholly disposed under the housing bezel, as viewed through the bezel aperture.

8. The display of claim 1, further comprising a capacitive touch controller coupled to the sensor electrodes, the controller operable to generate an electric field between sensor electrodes such that the electric field extends through and above the clear substrate, and the controller also operable to detect a disturbance in the electric field above the clear substrate.

9. The display of claim 8, wherein the display panel is configured to display an icon in proximity to an electric field of the sensor electrodes near a periphery of the display aperture, the icon configured to represent a function, wherein disturbance of the electric field in proximity to the icon will cause the touch controller to initiate the execution of that function.

10. The display of claim 1 wherein the circuit board includes a bridge across the display aperture, wherein further sensor electrodes are disposed on the bridge.

11. The display of claim 1, wherein the display panel is disposed within the display aperture of the circuit board.

12. A device display with touch sensor, the display comprising:
a housing bezel with a bezel aperture;
a clear substrate;
a display panel;
a circuit board having a display aperture, the circuit board abutting the clear substrate and the display panel abutting the circuit board, wherein the clear substrate, circuit board, and display panel are assembled with the housing bezel such that a portion of the display can be viewed through the bezel aperture, through the clear substrate, and through the display aperture; and
a plurality of sensor electrodes disposed around the display aperture of the circuit board, wherein the sensor electrodes are at least partially disposed under the housing bezel, as viewed through the bezel aperture, and wherein the clear substrate includes an opaque coating covering any sensor electrodes exposed within the bezel aperture as viewed through the bezel aperture.

13. The device of claim 12, further comprising a capacitive touch controller coupled to the sensor electrodes, the controller operable to generate an electric field between sensor electrodes such that the electric field extends through and above the clear substrate within the bezel aperture, and the controller also operable to detect a disturbance in the electric field above the clear substrate within the bezel aperture.

14. The display of claim 12, wherein the display aperture is not smaller than the bezel aperture, and wherein the sensor electrodes are wholly disposed under the housing bezel, as viewed through the bezel aperture, and further comprising a capacitive touch controller coupled to the sensor electrodes, the controller operable to generate an electric field between sensor electrodes such that the electric field extends through and above the clear substrate within the bezel aperture, and the controller also operable to detect a disturbance in the electric field above the clear substrate within the bezel aperture, and wherein the display panel is configured to display an icon in proximity to an electric field of the sensor electrodes near a periphery of the bezel aperture, the icon configured to represent a function, wherein disturbance of the electric field in proximity to the icon will cause the touch controller to initiate the execution of that function.

15. A device display with touch sensor, the display comprising:
a housing bezel with a bezel aperture;
a clear substrate;
a display panel;
a circuit board having a display aperture of the same size as the bezel aperture, the circuit board abutting the clear substrate and the display panel abutting the circuit board, wherein the clear substrate, circuit board, and display panel are assembled with the housing bezel such that the display aperture and bezel aperture are aligned and a portion of the display can be viewed through the bezel aperture, through the clear substrate, and through the display aperture;
a plurality of sensor electrodes disposed around the display aperture of the circuit board, wherein the sensor electrodes are wholly disposed under the housing bezel, as viewed through the bezel aperture, and
a capacitive touch controller coupled to the sensor electrodes, the controller operable to generate an electric field between sensor electrodes such that the electric field extends through and above the clear substrate within the bezel aperture, and the controller also operable to detect a disturbance in the electric field above the clear substrate within the bezel aperture, and wherein the display panel is configured to display an icon in proximity to an electric field of the sensor electrodes near a periphery of the bezel aperture, the icon configured to represent a function, wherein disturbance of the electric field in proximity to the icon will cause the touch controller to initiate the execution of that function.
